(19) United States
(12) Patent Application Publication
(10) Pub. No.: US 2002/0085540 A1
(43) Pub. Date: Jul. 4, 2002

(54) Telecommunication service provision in multi-network wireless telecommunication system

(76) Inventors: Jani Hyvarinen, Tampere (FI); Petri Uosukainen, Tampere (FI)

Correspondence Address: PERMAN & GREEN, 425 POST ROAD, FAIRFIELD, CT, 06430, US

(21) Appl. No.: 10/027,868

(22) Filed: Dec. 19, 2001

(30) Foreign Application Priority Data
Dec. 29, 2000 (FI) 20002887

(51) Int. Cl. H04L 12/66

(52) U.S. Cl. 370/352; 370/329

(57) ABSTRACT

A method for providing a telecommunication service in a wireless telecommunication system comprising a wireless local network, at least one public mobile network, at least one mobile station supporting both of the networks and at least one terminal. Availability of the requested data transmission service and reachability of the terminal in the local network is checked, if the mobile station is attached to the local network and data transmission is desired between the mobile station and the terminal. A service request is transmitted from the mobile station to the public mobile network in response to the data transmission service not being providable substantially in accordance with the service request and/or the terminal not being reachable via the local network.

### BACKGROUND OF THE INVENTION

The invention relates to providing telecommunication service in a wireless telecommunication system comprising a plurality of networks, and in particular, in a system comprising a local area network and a public land mobile network (PLMN).

Conventionally office information systems have been designed such that a telephone network and a data network that connects computers and their peripherals, typically a local area network, have been implemented as separate networks. Development and convergence of various data networks and telephone networks as well as needs of companies have resulted in developing systems to provide versatile data transmission services via local area networks. A significant contribution to this development has been improved applicability of IP (Internet Protocol) technology, conventionally employed in data networks, to telephone services.

In a modern office data system it is also possible to connect a mobile system to operate via a local network, whereby speech connections based on the mobile system protocol are also switched via e.g. an office-specific base station to mobile stations (MS) by means of a local area network (LAN) that is typically employing IP technology. In that case, the conventional private branch exchange (PBX) can be bypassed completely and broadband connections and excellent quality of speech can also be guaranteed in wireless data transmission within short distances. Mobile stations can establish wireless connections via the office-specific base station and the local area network to other mobile stations and terminals in the office. In this manner, the internal telephone traffic of the office can be managed at low costs. On the other hand, wireless connections provided by the wireless local area networks can also be used for other data transmission, such as file retrieval. The wireless local area networks can be provided with gateways, which take care of data transmission from the wireless local area network to the public switched telephone network (PSTN), for instance. Connections can be arranged via the gateway devices to a mobile switching centre (MSC), through which it is possible to communicate with terminals of the GSM system.

Arrangement of connections from local area networks to other networks causes various problems: gateway devices increase costs, data transmission service supply agreements must be made with operators of other networks and, at least in GSM-based local area networks, access to and control of the local area network must be arranged to the GSM network operator. Costs of the gateway devices decrease the feasibility of the wireless networks in small local area networks. Management of the local area network becomes more complicated and security risks increase.

### BRIEF DESCRIPTION OF THE INVENTION

The object of the invention is thus to provide a method and equipment implementing the method such that the above drawbacks can be avoided. This is achieved by a method, a wireless telecommunication system and a mobile station, which are characterized by what is disclosed in the independent claims. The preferred embodiments of the invention are disclosed in the dependent claims.

According to the invention, availability of a service requested by a user and reachability of a terminal are checked in a local network, when a mobile station user has a need to communicate with the terminal. The terminal to be reached may be another mobile station or a file server, for instance. If the requested service cannot be substantially provided as requested and/or the terminal cannot be reached via the local network, the data transmission service is requested from a public land mobile network (PLMN).

This allows to achieve a considerable advantage that possibility of failure in the service requested by the user of the mobile station can be minimized. Internal connections in the local network can be arranged without PLMN transmission charges and external connections can be arranged without that the local network needs elements providing connection to the PLMN. The local networks can thus be maintained completely independent, and the PLMN operator need not control these networks as they do in several prior art office systems. Planning and maintenance of the local network is not limited by the PLMN. It is possible to select a network providing the requested connection without user intervention.

According to one preferred embodiment of the invention, the local network is determined a primary network, wherefrom a service is requested whenever in the coverage area of the local network. This allows to achieve an advantage that more economical connections provided by the local network in its own area can automatically be used.

### BRIEF DESCRIPTION OF THE DRAWINGS

In the following, the invention will be described in greater detail in connection with preferred embodiments, with reference to the attached drawings, wherein

FIG. 1 shows a telecommunication system comprising a GSM/GPRS network and a local area network;

FIG. 2 shows a telecommunication system comprising a GSM/GPRS network and a local area network based on GSM technology;

FIG. 3 illustrates protocol stacks of a mobile station according to one preferred embodiment of the invention;

FIG. 4 is a flow chart of a data transmission service request procedure according to one preferred embodiment of the invention; and

FIG. 5 is a signalling chart of a data transmission service request in a system comprising a WLAN according to one preferred embodiment of the invention.

### DETAILED DESCRIPTION OF THE INVENTION

The invention can be applied to any system comprising a wireless local network and a public mobile network PLMN. The wireless local network may support e.g. IEEE802.11, BRAN (Broadband Radio Access Networks; Hiperlan1,2, Hiperaccess), Bluetooth or any other standard typically utilizing unlicensed radio frequencies. As will be set forth below, it is also possible to use public mobile network technology in the local network, for instance, by establishing a local company network based on GSM technology.

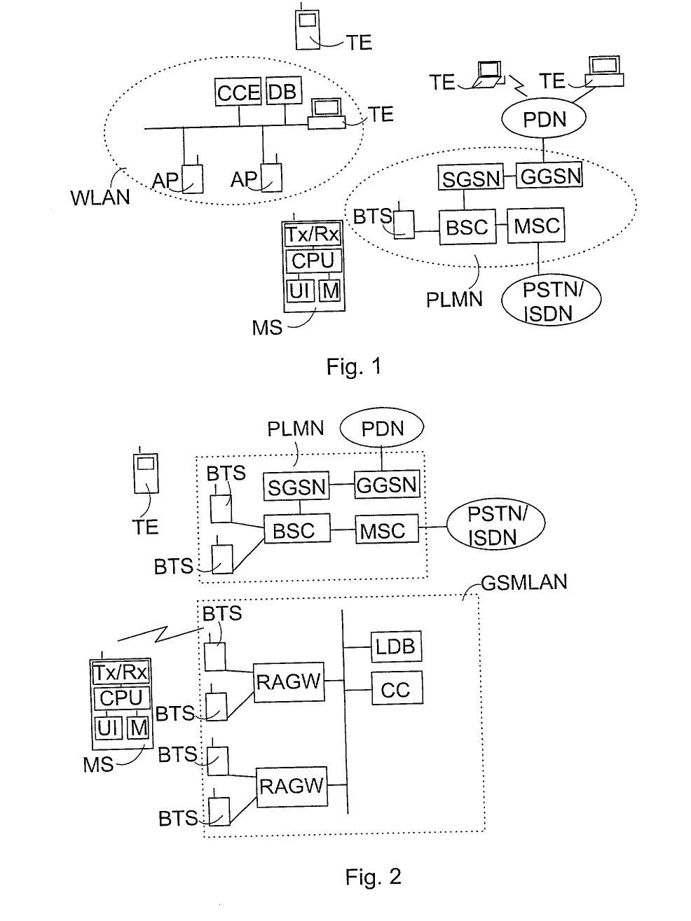

In the system of FIG. 1, a mobile station MS comprises means for establishing a data transmission connection to a local network WLAN and a public mobile network PLMN. The local network WLAN is an office-specific network of a company, for instance, and connected to the company's internal data network. WLAN comprises access points AP, a connection control entity CCE controlling the access points and the network operation and a database DB comprising location data of users. WLAN may also comprise a gateway to other telecommunication networks, such as PSTN, but the gateway is not necessary for the solution of the invention, however.

The local network WLAN is typically an IP-based network. From the local network WLAN, a connection may also be arranged to the Internet preferably through a firewall. The local network WLAN of FIG. 1 can be based on IEEE802.11, HiperLAN or Bluetooth standards. In the IEEE802.11 standard, the physical layer and MAC (Medium Access Control) layer are standardized.

The public mobile network of FIG. 1 is based on the GSM/GPRS (General Packet Radio Service) system, i.e. a base transceiver station BTS provides a mobile station MS with a wireless connection to the GSM network PLMN, which further comprises a base station controller BSC, a mobile switching centre MSC and possibly a serving GPRS support node SGSN and a gateway GPRS support node GGSN. MSC provides circuit switched connections for PSTN and ISDN networks and GGSN takes care of packet-switched data transmission to IP and X.25 networks.

FIG. 2 illustrates a telecommunication system according to one preferred embodiment of the invention comprising a public mobile network PLMN based on the GSM/GPRS system and a local area network implementation GSMLAN based on the GSM technology. GSMLAN is e.g. an office-specific wireless local area network which comprises base transceiver stations BTS supporting the GSM system and radio access gateways RAGW emulating the base station controller, a location database LDB, and a call control entity CC controlling the operation of the network and the radio access gateway RAGW. The radio access gateway RAGW performs a protocol conversion on the data to be transmitted from GSM Abis interface frames to packets of an IP network protocol, such as H.323 or SIP protocol, and vice versa. Because the radio access gateway RAGW emulates the base station controller and the radio interface is in accordance with the GSM standard, the mobile station's MS GSM functionality allows to establish a connection also to the local network by means of.

LDB may communicate with the GSM mobile switching centre MSC via an A interface gateway AGW and with the GSM home location register HLR via a MAP (Mobile Application Part) gateway MAPGW. It is possible to arrange a connection to PSTN/ISDN networks via a gateway GW. It should be noted that gateways AGW, GW, MAPGW are not necessary for the local network GSMLAN of the invention, because connections to external networks can be arranged via the public mobile network PLMN. However, there is typically connection from an IP-based local area network GSMLAN to the Internet through a firewall. The public mobile network PLMN can be the GSM/GPRS network described above in connection with FIG. 1.

In the systems of FIGS. 1 and 2, the mobile station MS comprises a memory M, transceiver means Tx/Rx, user interface means UI and processing means CPU comprising at least one processor. MS can also be connected to a portable computer, for instance. MS supports at least the local network WLAN, GSMLAN and the public mobile network PLMN. MS may support the networks in various ways:

1) MS is a complete dual/multimode mobile station, i.e. MS comprises different radios for different networks. MS thus supports the simultaneous use of two protocol stacks, i.e. providing two, substantially simultaneous, data transmission services from different networks, for instance, speech service from PLMN and packet-switched data transmission service from the local network WLAN, GSMLAN. It is assumed in this implementation that MS is always attached to the public mobile network PLMN and also always attempts to access the local network. At the application level it is possible to select which one of the radios is used during two simultaneous voice calls, for instance.

2) MS is a partly dual/multimode mobile station, i.e. it comprises two radios but a common state machine. In that case, the data transmission connection can only be active to one of the networks. In order that MS could receive paging messages also while being attached to a possibly closed local network, MS is still capable of attaching to the local network WLAN, GSMLAN and the public land mobile network PLMN, i.e. of updating its location in the networks and listening to paging messages of the networks. Paging messages of another network can also be advantageously listened to, when data transmission resources have been reserved therefrom and the mobile station is arranged to transmit and receive user data.

3) Only one radio at a time can be in use, i.e. MS can be attached to only one network. In that case, when MS attaches to a local network, it must be detached from the public mobile network, i.e. IMSI (International Mobile Subscriber Identifier) detach must be performed in the GSM network. This is not desirable from the viewpoint of the user, and hereinafter the invention will be described according to the embodiment of alternative 1) or 2).

Advantageously, after power switch-on, MS tends to attach automatically to the local network WLAN, GSMLAN and to the public mobile network PLMN. If one of the networks is not available, MS may monitor the network frequencies and retry attachment at a later stage. It is also possible that attachment to the local area network requires user initiative when the network coverage area is entered.

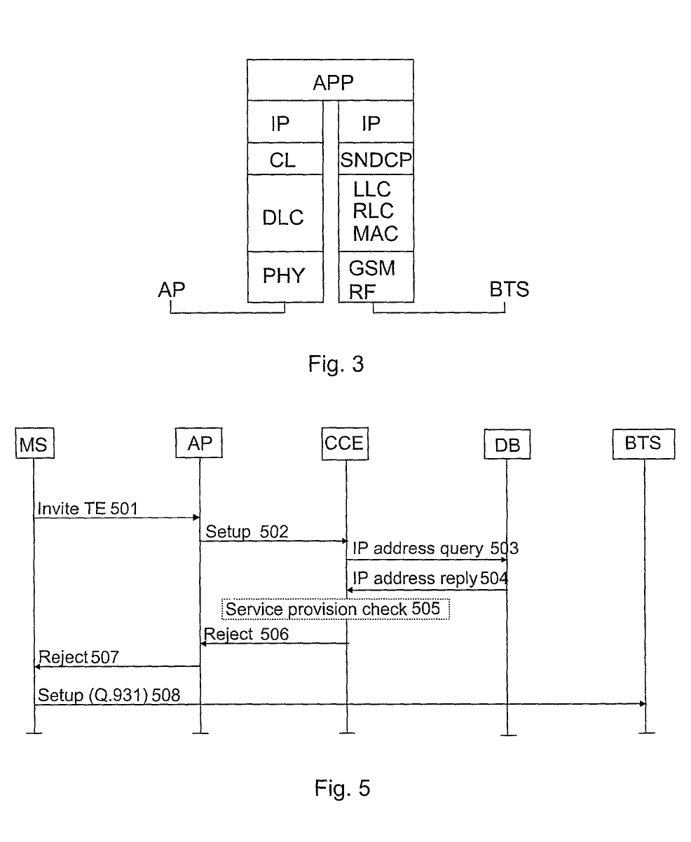

FIG. 3 illustrates protocol stacks of a mobile station MS according to one preferred embodiment of the invention. MS corresponds with the one described above in alternative 1), i.e. it comprises protocol stacks for a local network WLAN and a public mobile network PLMN. In FIG. 3, WLAN is in accordance with HiperLAN/2 standard, the protocol stack consisting of a physical layer PHY, a data link control layer DLC and a convergence layer CL. DLC comprises sublayers: a MAC (Medium access control) layer, an error control layer and a radio link control layer. For upper layers FIG. 3 shows an IP layer and an application layer APP. The application layer APP is common to the protocol stacks of both the local network WLAN and the public mobile network PLMN. FIG. 3 shows a GPRS protocol stack known to a person skilled in the art and comprising an IP network layer IP, a subnetwork dependent convergence protocol layer SNDCP, an LLC layer, an RLC layer, a MAC layer and a physical level transmission layer GSM RF.

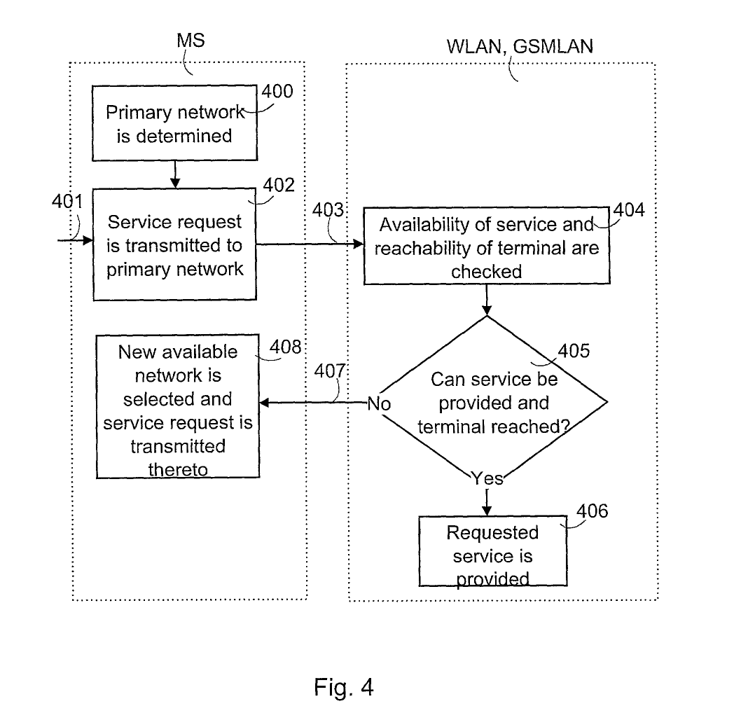

FIG. 4 illustrates requesting a data transmission service according to one preferred embodiment of the invention. A primary network is preferably determined 400 for a mobile station MS, i.e. a network, from which data transmission service is desired if several networks are available. In addition to the primary network, it is also possible to determine a plurality of networks next in order, from which service is desired next. Determination of the primary network differs from a typical network order list, because, in general, a system (PLMN or LAN) is selected and because a network to address a service request to, not to be attached to, is selected. Advantageously, the primary network can be determined in the memory of the mobile station MS such that it can be changed in case of a fault. The primary network can also be determined 400 in an IC card attached to MS, whereby the same primary network can be used irrespective of the mobile device. The GSM subscriber identity module SIM included in the mobile station typically comprises a separate PLMN network list (Preferred PLMNs), according to which MS selects a public mobile network operator whose network MS attaches to. In order that advantages, such as lower transmission costs, provided by the local network WLAN, GSMLAN could be utilized, the local network is determined 400 to be the primary network.

A terminal TE shown in FIGS. 1 and 2 can be a second mobile station attached to the local network WLAN, GSMLAN, a mobile station attached to a public land mobile network PLMN, a wireless or wired terminal that is reachable in any other network (PDN, ISDN/PSTN), or a server providing the service. If a server is concerned, the server may provide a plurality of services, whereby the service to be used is identified on the basis of the number transmitted from the mobile station. A need to transmit data between the mobile station MS and the terminal TE is substantial. When the user of the mobile station MS expresses 401 a need for data transmission service via the user interface, the mobile station MS checks 402 the primary network, which hereinafter is assumed to be a local network (WLAN, GSMLAN).

MS sends the local network WLAN, GSMLAN a service request 403 for a data transmission service to the terminal TE. MS may decide on sending the request 403 to the local network WLAN, GSMLAN to which MS is already attached, or to an available local network to which it is not yet attached. If MS is not yet attached to the local network WLAN, GSMLAN, it will do so prior to sending the service request 403. If GSMLAN is in question, this requires allocating radio resources for signalling in the base transceiver station BTS and the radio access gateway RAGW. If WLAN is in question, authentication of the mobile station and resource allocation are performed at an access point AP prior to sending the service request 403. Data on reachable mobile stations MS (and terminals TE) and locations thereof is stored in a location database DB, LDB in connection with the attachment. This mobility management process can be called a PIU (Presence Information Update) process. PIU is also performed periodically on the initiative of the network or the mobile station so as to update the location data of the mobile stations that are attached the local network.

When the local network WLAN, GSMLAN receives the service request 403, the network checks 404 the availability of the requested service and the reachability of the terminal TE.

The availability of the service may be defined on the basis of a variety of criteria, the most important of which are the following:

Is the network able to provide the service type (packet-switched, circuit-switched) requested by the mobile station?

Has the network sufficient capacity?

Can the network guarantee one or more service quality parameters possibly requested? These quality parameters typically include error, delay and bit rate.

At least the first two criteria should be fulfilled, in order that the data transmission service could be provided to the mobile station MS. The quality of service is often controlled from end to end on upper levels on behalf of the application, and there is no separate service quality check within the local network GSMLAN, WLAN. If the quality of service can be selected and checked, the service request 403 may include particular, determined criteria lo relating to the quality of service, the availability of which the primary network checks 404. For instance, MS may request for a transmission service of packet-switched data. A checking algorithm 404 can be implemented in a variety of ways based on different criteria, and in particular regarding the quality of service parameters, it is not always necessary to provide all the required parameters.

The reachability of the terminal TE can be checked by analyzing the dialled number included in the service request 403. The local network typically employs the same MSISDN (Mobile Station ISDN Number) numbers as the public land mobile network PLMN, however, it is possible to associate the numbers with those employed in the local network. For instance, in an IP-based network WLAN data transmission is based on IP addresses, and consequently the IP addresses corresponding to the MSISDN numbers of the mobile stations can be stored in the database DB. The local networks WLAN, GSMLAN may also use a numbering plan of their own, whereby it is readily detected in the network whether the number in question is that of the local network numbering plan. However, the separate numbering plan makes the terminal use two separate numbers, which may be complicated. The identifier of the terminal TE included in the service request 403 may also be directly an IP address, or in the case of WLAN, a host name of a server, for instance.

According to a preferred embodiment, it is possible to check in the location database DB, LDB of the local network WLAN, GSMLAN whether the terminal TE having the dialled number is attached to the local network. If the terminal TE cannot be reached via the local network and the local network WLAN, GSMLAN comprises at least one gateway (GW, AGW) a connection establishment request can be directed to the gateway which attempts to establish a logical connection via a third, external network PSTN/ISDN or the Internet to the called number. A connection control entity CCE, CC can be arranged to direct the connection establishment request to the gateway if the called number indicates, for instance on the basis of a particular prefix, that a PSTN number of a particular country is concerned. In that case the service request and the second number can be transmitted to the gateway which establishes a connection to a third network. However, it should be noted that the solution of the invention has an advantage that gateway devices are not necessary in the local networks.

If said primary network can be used on the basis of the check 405, i.e. the requested data transmission service can be provided and the terminal TE is reachable, a logical connection is established 406 to the terminal TE in accordance with the service request 403. The local network WLAN, GSMLAN may also comprise a setting, according to which the connection is established to a voice mail box if the terminal TE is engaged or unreachable.

If the primary network cannot provide the service substantially according to the request 403 and/or the terminal TE is not reachable via the local network WLAN, GSMLAN, the local network sends 407 a message to the mobile station MS. When the mobile station MS receives the message 407, it transmits 408 a service request to the public land mobile network PLMN. If MS is not yet attached to the public land mobile network PLMN, MS performs attachment prior to sending the request 408, i.e. an IMSI attach function or a location update in the GSM network. Network changeover can be implemented in three different ways a), b) and c):

a) The local network WLAN, GSMLAN sends the mobile station MS a service reject message 407 typically used in the network. A list is stored in the mobile station MS, according to which list MS requests service from a network that is next in order after the primary network. In response to the message 407, MS is arranged to check 408 in the list the next network (PLMN) and to transmit a service request thereto.

b) The local network WLAN, GSMLAN is arranged to send the mobile station MS a command to transmit a service request to any other network in the message 407. In response to the command 407, MS determines a network, advantageously on the basis of the list, to which the service request should be transmitted. MS transmits the service request to the determined network.

c) The local network WLAN, GSMLAN is arranged to determine a network to which the mobile station should transmit a service request. The local network can maintain a list on the public mobile networks PLMN in the area, for instance, and possibly determine for the mobile stations MS the PLMN networks to be used, preferably attempting to get MS in a network PLMN owning the SIM. In the message 407, the local network sends a command to transmit the service request to the determined public mobile network.

A connection to the public mobile network PLMN can be established 408 in a manner known per se, and depending on the capabilities, MS may remain monitoring the base transceiver stations BTS or the access points AP of the local network WLAN, GSMLAN. In the location database DB, LDB the called number may be associated with a second number in a third network, such as PSTN. According to one embodiment, the message 407 sent from the local network may comprise a second number, for instance a gateway number. In that case, MS can establish a connection to the second number via the public mobile network, i.e. set the second number in the connection request to be the called number. The user can be asked for validation prior to call set-up according to the second number.

The functionality described above in connection with FIG. 4 can be well implemented in the local network WLAN of FIG. 1 or in the local network GSMLAN of FIG. 2 based on the GSM technology.

FIG. 5 illustrates how service is provided in the system of FIG. 1. MS transmits 501 to an access point AP of WLAN a service request for data transmission to a terminal TE. The request 501 comprises data on the service desired and an identifier, such as MSISDN number or IP address, that identifies TE. AP transmits 502 the service request to a connection control entity CCE that processes it. CCE transmits 503 a database inquiry comprising the TE identifier to a database DB. In addition to the database, DB (and LDB) further comprise means for retrieving and storing the data of the database. The TE identifier is searched from the data. The database replies 504 to the inquiry 503. If TE is reachable, CCE preferably checks 505 at this stage whether the service can be provided substantially in accordance with the service request 502.

In this example, the terminal TE is not reached, so the connection control entity CCE need not perform the check 505. CCE returns 506 reject information to the access point AP. AP forwards 507 the information to the mobile station MS. The changeover may take place in accordance with the above-described alternatives a), b) and c), i.e. upon receiving the service reject message, MS is always set to request service from PLMN, for instance, or CCE may also send a message 506, 507 which comprises a command to request service from the public mobile network PLMN. Upon receiving the message 507, MS establishes a signalling connection to a base transceiver station BTS and transmits 508 the setup message of the GSM standard to the base transceiver station. Thereafter the service can be provided, if PLMN enables it, in the known manner according to the GSM standard, which need not be described herein in greater detail. For a more detailed description of the GSM/GPRS network operation reference is made to the ETSI GSM/GPRS standard specifications and The GSM system for Mobile Communications by M. Mouly and M. Pautet, Palaiseau, France, 1992, ISBN:2-957190-07-7.

In GSMLAN the call control entity CC controls the radio access gateway RAGW, and consequently CC checks (404) the availability of the service particularly on the basis of the radio access gateway RAGW characteristics and the reachability of the terminal TE by means of the database LDB. In a system comprising GSMLAN it is also possible to operate according to the alternatives a), b) and c) if the service is not obtained from the local network and/or the terminal cannot be reached via the local network. The mobile station MS is arranged to transmit a service request to the public mobile network PLMN in response to the message. The messages between the base transceiver station BTS and the mobile station MS can be in accordance with the GSM standard, except for alternatives b) and c), in which a command to change network (b) or a command to change network into a determined network (c) is transmitted in the message 407.

According to one preferred embodiment of the invention, the mobile station MS already attempts to find out if it is worthwhile to try to reach the terminal TE in the local network WLAN, GSMLAN. When the mobile station has attached to the local network, and the desire is to transfer data between the mobile station and the terminal, it is checked in the mobile station whether the terminal belongs to the local network. The check can utilize location data obtained from a satellite-based GPS (Global Positioning System) system or base station measurements, contact data stored in the mobile station or location data included in the databases DB, LDB of the local network WLAN, GSMLAN. If TE belongs to the local network on the basis of the check, the service request 403 is transmitted from the mobile station to the local network (primary network). If TE does not belong to the local network on the basis of the check, the service request can be transmitted (408) directly to the public mobile network PLMN. Advantageously, PLMN can be selected by means of the list maintained in the mobile station.

Data on terminals TE belonging to the primary network, i.e. local network WLAN, GSMLAN, can be stored in the mobile station contact data. When the user selects TE, MS checks whether TE is entered among those belonging to the local network. For instance, company servers and terminals TE of employees can be determined to belong to the local area network of the company. The check can also be carried out on the basis of the TE identifier, i.e. the identifiers belonging to the determined number or IP address domain belong to the local network. An advantage with this embodiment is that it avoids unnecessary signalling to the primary network (local network WLAN, GSMLAN), which may delay service, if the terminal TE did not belong to the local network.

The mobile station MS can also maintain location data of the terminals TE collected in the GPS location data or the location database DB, LDB and transmitted by the local network WLAN, GSMLAN. The data on whether TE is attached to the local network WLAN, GSMLAN is also preferably conveyed in connection with the location data. On the basis of the location data maintained in the mobile station, it is possible to check whether TE belongs to the local network, and further, preferably whether TE is reachable via the local network WLAN, GSMLAN. The mobile stations MS and the terminals TE may comprise GPS receivers, the location data determined thereby being updated into the network, and from the network to the mobile stations and terminals, or directly between the terminals and the mobile stations. The location data can be transmitted to the mobile station MS as it accesses the local network WLAN, GSMLAN, for instance.

According to one preferred embodiment of the invention, the mobile station MS may attempt for a handover from the public mobile network PLMN to the local network WLAN, GSMLAN, or vice versa, also during an active service.

The mobile station MS can also measure signal levels of the local network base transceiver stations BTS or access points AP, when the public mobile network provides data transmission service to the mobile station. MS transmits a service request to the local network WLAN, GSMLAN for data transmission service, if the access point AP or the base transceiver station BTS of the local network can provide a sufficient signal level, which is preferably predetermined in the mobile station MS. The local network checks the availability of the data transmission service and the reachability of the terminal. A connection to the terminal TE is established via the local network, if the data transmission service can be provided substantially in accordance with the service request and the terminal can be reached via the local network. The connection to the terminal TE via the public mobile network can be released preferably after establishing a connection via the local network. Packet-switched services, such as the GPRS network services, have a particular advantage of the handover back to the local network, because in said services packet data protocol context typically remains active all the time, even though no data would be transferred.

The mobile station MS can also measure signal levels of the base transceiver stations included in the public mobile network PLMN, when the local network WLAN, GSMLAN provides data transmission service to the mobile station. A service request is transmitted from the mobile station to the public mobile network, if the signal level of the local network access points and base transceiver stations is substantially lower than the signal level of a base transceiver station in the public mobile network. Advantageously, a particular threshold value is used for the signal level of the local network, whereby the signal level of the local network having dropped below the threshold value, a service request is transmitted to the public mobile network. The connection to the local network is released after establishing a connection to the terminal via the public mobile network. In the above-described handovers from the local network to the public mobile network and vice versa, a time limit is preferably used and the service request is not transmitted until said time has elapsed. The time limit can be 20 seconds, for instance. This allows to avoid sending unnecessary service requests.

The above-described functionality can be implemented by means of software in network elements (preferably CCE or CC) of the local network WLAN, GSMLAN and by means of memories (M) and processors (CPU) existing in the mobile station MS. It is also possible to use integrated circuits. It is also possible to load software in the mobile station MS over the network, and execution of said program makes MS operate in the above described manner.

It is obvious to a person skilled in the art that as technology advances the basic idea of the invention can be implemented in a variety of ways. The public mobile network PLMN can be, for instance, a third-generation UMTS (Universal Mobile Telecommunications System) network, which in many respects is based on network elements of the backbone network developed for the GSM system and providing circuit-switched and packet-switched services. Thus, the invention and the embodiments thereof are not restricted to the above-described examples but they may vary within the scope of the claims.

What is claimed is:

1. A method for providing a telecommunication service in a wireless telecommunication system which comprises at least one wireless local network, at least one public mobile network, at least one mobile station supporting both of the networks and at least one terminal, the method comprising the steps of:
checking availability of the requested data transmission service and reachability of the terminal in the local network in response to the mobile station being attached to the local network and data transmission being desired between the mobile station and the terminal,
transmitting a service request from the mobile station to the public mobile network in response to the data transmission service not being providable substantially in accordance with the service request and/or the terminal not being reachable via the local network.

2. A method as claimed in claim 1, wherein a primary network is determined in the mobile station,
the primary network determined in the mobile station is checked when a need arises to transfer data between the terminal and the mobile station, and
the availability of the requested data transmission service and the reachability of the terminal first in the primary network are checked in response to the mobile station being located in the coverage area of the primary network.

3. A method as claimed in claim 1, wherein
the mobile station checks whether the terminal belongs to the local network in response to the mobile station being attached to the local network and data transmission being desired between the mobile station and the transfer,
the service request is transmitted from the mobile station to the local network in response to the terminal belonging to the local network, or the service request is transmitted to the public mobile network.

4. A method as claimed in claim 1, wherein
a service request is transmitted from the mobile station to the local network,
the availability of the requested data transmission service and the reachability of the terminal are checked,
a message is transmitted from the local network to the mobile station in response to the data transmission service not being providable substantially in accordance with the service request and/or the terminal not being reachable via the local network, and
the service request is transmitted from the mobile station to the public mobile network in response to said message received from the local network.

5. A method as claimed in claim 4, wherein
said message comprises a command to transmit the service request to another network.

6. A method as claimed in claim 5, wherein the local network determines the network whereto the mobile station should send the service request,
said message comprises a command to transmit the service request to the determined public mobile network, and
the service request is transmitted to the public mobile network determined in said message.

7. A method as claimed in claim 4, wherein
the mobile station maintains a list on networks wherefrom services are sought,
the mobile station determines, in response to said message, the network whereto the service request should be transmitted, and
the service request is transmitted to the public mobile network determined on the basis of the list.

8. A method as claimed in claim 4, wherein
a location database of the local network is checked to determine whether the terminal of the called number included in the service request is attached to the local network, and
said message is transmitted from the local network to the mobile station in response to the terminal not being attached to the local network.

9. A method as claimed in claim 8, wherein the called number is associated in the location database with a second number,
said message comprises the second number, and
the service request comprising said second number is transmitted to the public mobile network.

10. A method as claimed in claim 1, wherein the mobile station also measures signal levels of base transceiver stations or access points comprised by the local network in response to the public mobile network providing data transmission service to the mobile station,
a service request is transmitted from the mobile station to the local network for obtaining the data transmission service in response to the access point or base transceiver station of the local network providing a sufficient signal level,
the availability of the data transmission service and the reachability of the terminal in the local network are checked,
a connection to the terminal via the local network is established in response to the data transmission service being providable substantially in accordance with the service request and the terminal being reachable via the local network, and
the connection to the terminal via the public mobile network is released.

11. A method as claimed in claim 1, wherein
the mobile station also measures signal levels of the base transceiver stations comprised by the public mobile network in response to the local network providing data transmission service to the mobile station,
the service request is transmitted from the mobile station to the public mobile network in response to the signal levels of the measured access points or base transceivers stations of the local network being substantially lower than the signal level of the base transceiver station of the public mobile network, and
the connection to the local network is released after establishing a connection to the terminal via the public mobile network.

12. A wireless telecommunication system comprising a wireless local network, at least one public mobile network, at least one mobile station supporting both of the networks and at least one terminal, wherein
the system is configured to check availability of a data transmission service and reachability of a terminal in the local network in response to the mobile station being attached to the local network and data transmission being desired between the mobile station and the terminal,
the mobile station is configured to transmit a service request to the public mobile network in response to the data transmission service not being providable substantially in accordance with the service request and/or the terminal not being reachable via the local network.

13. A telecommunication system as claimed in claim 12, wherein
the mobile station is configured to check whether the terminal belongs to the local network in response to the mobile station being attached to the local network and the data transmission being desired between the mobile station and the terminal,
the mobile station is configured to transmit the service request to the local network in response to the terminal belonging to the local network, or
the mobile station is configured to transmit the service request to the public mobile network.

14. A telecommunication system as claimed in claim 12, wherein
the mobile station is configured to transmit the service request to the local network,
the local network is configured to check the availability of the requested data transmission service and the reachability of the terminal,
the local network is configured to transmit a message to the mobile station in response to the data transmission service not being providable substantially in accordance with the service request and/or the terminal not being reachable via the local network, and
the mobile station is configured to transmit the service request to he public mobile network in response to said message received from the local network.

15. A telecommunication system as claimed in claim 14, wherein
the local network is configured to determine the network whereto the mobile station should transmit the service request,
the local network is configured to send a command in said message to transmit the service request to a determined public mobile network, and
the mobile station is configured to transmit the service request to the public mobile network determined in said message.

16. A telecommunication system as claimed in claim 14, wherein
the mobile system is configured to maintain a list on networks from which service is sought,
in response to said message, the mobile station is configured to determine a network on the list, whereto the service request should be transmitted, and
the mobile station is configured to transmit the service request to the public mobile network determined on the basis of the list.

17. A telecommunication system as claimed in claim 12, wherein
the local network supports IEEE802.11 standard or is based on GSM-standard-supporting base transceiver stations and radio access gateways performing protocol conversion between the IP network and the GSM network, and
the public mobile network supports the GSM standard.

18. A mobile station comprising means for establishing a data transmission connection to a wireless local network and to a public mobile network, wherein the mobile station is configured to transmit a service request to the local network in response to the mobile station being attached to the local network and data transmission being desired between the mobile station and a terminal, and
the mobile station is configured to transmit the service request to the public mobile network in response to the data transmission service not being providable in the local network substantially in accordance with the service request and/or the terminal not being reachable via the local network.

19. A mobile station as claimed in claim 18, wherein the mobile station is configured to check whether the terminal belongs to the local network, and
the mobile station is configured to transmit the service request to the public mobile network in response to the terminal belonging to the local network.

20. A mobile station as claimed in claim 18, wherein
he mobile station is configured to maintain a list on networks wherefrom service is sought,
in response to a service reject message sent by the local network, the mobile station is configured to determine a network on the list whereto the service request should be transmitted, and
the mobile station is configured to transmit the service request to the public mobile network determined on the basis of the list.
